(19) United States
(12) Patent Application Publication
(10) Pub. No.: US 2010/0147546 A1
(43) Pub. Date: Jun. 17, 2010

(54) EXPANDED METAL LIGHTNING PROTECTION FOILS WITH ISOTROPIC ELECTRICAL RESISTANCE

(76) Inventors: Kenneth Mull, Woodbridge, CT (US); Robert Bochman, Higganam, CT (US)

Correspondence Address: Ballard Spahr LLP, SUITE 1000, 999 PEACHTREE STREET, ATLANTA, GA, 30309-3915, US

(21) Appl. No.: 12/332,819

(22) Filed: Dec. 11, 2008

(51) Int. Cl. H02G 13/00

(52) U.S. Cl. 174/2; 174/126.1; 29/6.1

(57) ABSTRACT

The present disclosure provides an expanded metal having substantially isotropic electrical resistance in at least two dimensions. Also disclosed are a composite structure comprising an expanded metal as disclosed herein and a lightning protection system comprising the expanded metal. Methods for manufacturing the expanded metal are also disclosed.

### BACKGROUND OF THE INVENTION

1. Field of the Invention

The present invention relates to lightning protection systems and materials used therein.

2. Technical Background

Lightning protection is a requirement for aircraft and aerospace structures to ensure safe flight and prevent damage to aircraft components. Lightning discharges to or from an aircraft, if not quickly dispersed, can cause serious damage to aerospace components, such as, for example, delamination and/or embrittlement, and can cause electrical interference with, for example, avionics systems. Typical lightning strikes can result in localized temperatures of about 20,000° C. or higher and electrical currents of 250,000 amperes or more. During flight, aircraft can often trigger lightning, such as, for example, when flying into a heavily charged area of a cloud.

Many aerospace structures are made of aluminum. The relatively high electrical conductivity of such aluminum structures ensures that the energy from a lightning strike can remain on and be dissipated across the aircraft's exterior surface. Other aerospace structures can be comprised of composite materials, such as, for example, fiber reinforced polymer (FRP) materials.

Lightning protection systems are of particular concern for such composite aerospace structures. Composite materials are typically less conductive than their aluminum counterparts and thus, less able to dissipate the energy resulting from a lightning strike.

The traditional engineering approach to protecting FRP structures from lightning has been to include a thin layer of metal foil or screen in the outer layer of the composite. When struck by lightning, the metal can be instantly vaporized into a plasma ball that very rapidly disperses the energy, sacrificially protecting the FRP structure underneath. The metal may be solid foil, expanded foil, woven wire screen, or wire interwoven into the fiber matrix.

The metals used in a traditional lightning protection system can be selected for their ability to absorb energy (heat of vaporization), electrical conductivity, and inertness relative to the graphite fibers in the FTP. Most lightning protection systems utilize aluminum or copper containing components. Aluminum has a high capacity to absorb energy and is an excellent conductor per unit of weight, but has a high electrochemical potential with graphite. In contrast, copper and its alloys are not as capable as aluminum in absorbing energy per unit weight, but have a low reaction potential with graphite.

In addition to protecting aerospace structures from physical damage, lightning protection systems should also shield wires and electrical components from electromagnetic interference that can result from a lightning strike.

There is a need to address the aforementioned problems and other shortcomings associated with traditional lightning protection systems. These needs and other needs are satisfied by the expanded metal technology of the present invention.

### SUMMARY OF THE INVENTION

The present invention relates to lightning protection systems, and specifically to lightning protection systems comprising an expanded metal component and suitable for use in a fiber reinforced polymer structure

In a first aspect, the present invention provides an expanded metal having substantially isotropic electrical resistance in at least two dimensions.

In a second aspect, the present invention provides a Faraday cage comprising an expanded metal having substantially isotropic electrical resistance in at least two dimensions.

In a third aspect, the present invention provides a method of making an expanded metal, the method comprising forming a plurality of openings in a metal sheet good, and stretching the metal sheet good in at least a first direction so as to form an expanded metal having predetermined electrical resistance in each of the first direction and a second direction perpendicular thereto.

Additional aspects and advantages of the invention will be set forth, in part, in the detailed description, figures, and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain aspects of the present invention and together with the description, serve to explain, without limitation, the principles of the invention. Like numbers represent the same elements throughout the figures.

FIG. 1 is a schematic illustration of an expanded metal material, in accordance with the various aspects of the present disclosure.

FIG. 2 is a schematic illustration of an opening of an expanded metal, in accordance with the various aspects of the present disclosure.

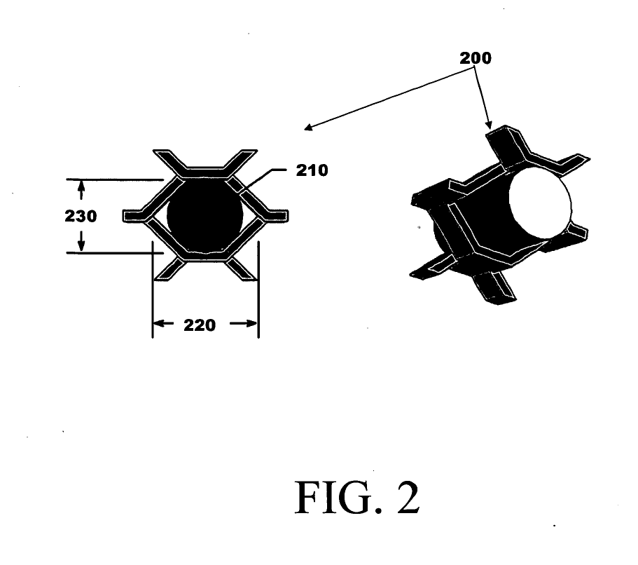

### DETAILED DESCRIPTION OF THE INVENTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its currently known embodiments. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes aspects having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optionally substituted component” means that the component can or can not be substituted and that the description includes both unsubstituted and substituted aspects of the invention.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As briefly introduced above, the present invention provides a lightning protection system comprising an expanded metal.

### Expanded Metal

The expanded metal can comprise any metal suitable for use in a lightning protection system. In various aspects, the expanded metal can comprise a transition metal, an inert metal, and/or an alloy or combination thereof. In one aspect, the expanded metal can comprise a single metal. In another aspect, the expanded metal can comprise multiple metals either in an alloy, a mixture, or in discrete phases or portions thereof.

In a specific aspect, the expanded metal can comprise aluminum or an alloy thereof. In another specific aspect, the expanded metal can comprise copper or an alloy thereof. In other aspects, the expanded metal can comprise any metal or combination of metals that are compatible with other components in an aerospace structure in which the expanded metal is or will be positioned. For example, in one aspect, the expanded metal comprises a metal having an electrochemical redox potential suitable for use with carbon materials, such as, for example, graphite. In a specific aspect, the metal of metals of the expanded metal are selected so as to reduce or eliminate the possibility of a redox reaction or other chemical or electrochemical interaction between the metal or metals and the other components of the structure, such as, for example, an aerospace structure, in which the expanded metal is positioned.

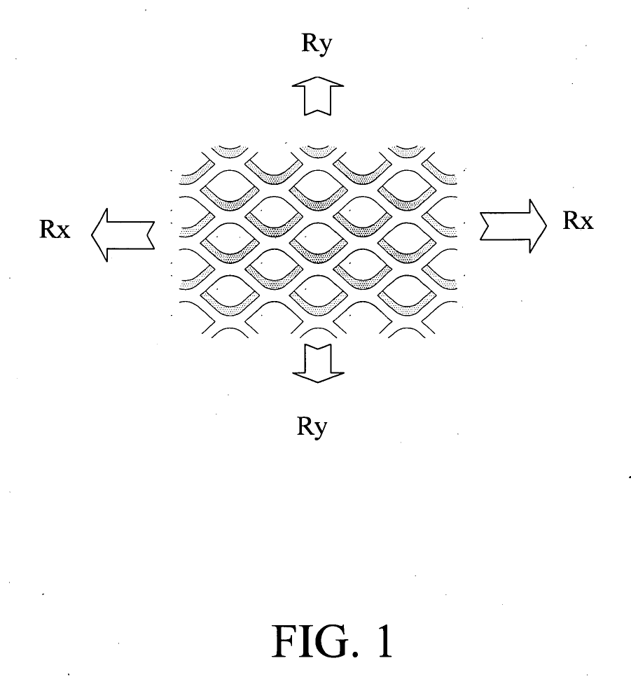

The expanded metal can have any dimensions suitable for use in a lightning protection system. In various aspects, the expanded metal can be a planar material, such as a sheet. In one aspect, the expanded metal can comprise a continuous sheet. In another aspect, the expanded metal can comprise one or more discrete pieces of an expanded metal having either the same or different compositions, dimensions, and/or properties. In one aspect, the expanded metal is a planar material having at least two dimension, such as, for example, the length and width, of the material, as illustrated in FIG. 1. The specific length and width of any one or more expanded metal components can vary, depending upon, for example, the intended application, and the present disclosure is not intended to be limited to any particular dimensions, for example, length and width, of an expanded metal component.

The thickness of an expanded metal component can also vary, depending upon the specific metal or metals utilized to form the expanded metal, the physical properties of the metal or metals, the desired physical properties of the final expanded metal component, and/or the requirements of the intended application. In various aspects, the thickness of an expanded metal component can range from about 0.001 inches to about 0.030 inches, for example, about 0.001, 0.002, 0.005, 0.008, 0.010, 0.012, 0.015, 0.018, 0.020, 0.023, 0.026 inches. In other aspects, the thickness of an expanded metal component can be less than about 0.001 inches or greater than about 0.030 inches. One of skill in the art can appreciate that the thickness of any particular expanded metal component can vary depending on, for example, the absorption energy of the material. In one aspect, the thickness of any one or more expanded metal components is uniform or substantially uniform across all or a portion of the component. In other aspects, the thickness of any one or more expanded metal components can vary across the component.

The expanded metal can have openings of any size and/or shape suitable for use in a lightning protection system. The openings of an expanded metal component, and the shape and size thereof, can affect the electrical resistance of the component in a given direction by, for example, changing the path length through which an electrical current must travel through the material. With reference to the Figures, an opening in an expanded metal 200 can, in one aspect, be described as a pin diameter 210. In another aspect, an opening can be described using the internal dimensions of the opening, for example, the LWD, or long way direction of the opening 220, and the SWD, or short way direction of the opening 230.

The open area of an expanded metal can vary, depending upon, for example, the properties of the expanded metal and the intended application. In various aspects, the percentage of open area of an expanded metal can range from about 10 to about 90 percent, for example, about 10, 15, 20, 25, 30, 35, 40, 45, 50, 55, 60, 65, 70, 75, 80, 85, or 90 percent; or from about 50 to about 85 percent, for example, about 50, 55, 60, 65, 70, 75, 80, or 85 percent. One of skill in the art could readily select an appropriate expanded metal component having a desired opening area for an intended application.

The size and shape of the openings of a traditional expanded metal are typically selected so as to control, for example, the physical strength of the material, the formability, or to control the degree of expansion (percentage of open space) and thus, the weight, or the material. Thus, such expanded metals typically exhibit substantially varying electrical resistance along the length and width of the expanded metal component. The present disclosure provides, in various aspects, an expanded metal in which the size and/or shape of any one or more openings in the expanded metal can be controlled so as to provide predetermined electrical resistance in one or more dimensions.

In various aspects, the size and shape of any one or more openings in an expanded metal can be selected so as to provide an isotropic or substantially isotropic electrical resistance in at least two dimensions. In a specific aspect, the size and shape of any one or more openings can be selected so as to provide an isotropic electrical resistance, wherein the electrical resistance is uniform or substantially uniform across the expanded metal's length and width.

It should be appreciated that the resistance value of a particular expanded metal can depend on a variety of factors and that one of skill in the art, based on this disclosure, determine an appropriate electrical resistance for a particular application. In various exemplary aspects, the electrical resistance of an expanded metal for use in a lightning protection system, such as described in the present disclosure, can range from about 0.05 mΩ/square to about 10.0 mΩ/square. In other aspect, an expanded metal component can have an electrical resistance of less than about 0.05 mΩ/square or greater than about 10.0 mΩ/square, and the present disclosure is not intended to be limited to any particular electrical resistance.

A typical expanded metal component utilized in a lightning protection system can have an electrical resistance in the LWD of from about 0.05 mΩ/square to about 3.0 mΩ/square, and an electrical resistance in the SWD of from about 0.17 mΩ/square to about 10.0 mΩ/square. Exemplary non-inventive typical expanded metal components can have, for example, a 3:1 ratio of electrical resistance in varying directions (SWD:LWD).

In contrast, the expanded metals of the present disclosure can have uniform or substantially uniform electrical resistance across the material's length and width. Expressed as a ratio, the electrical resistance (SWD:LWD) can range from about 1:1 to about 2:1, for example, about 1:1, 1.2:1, 1.5:1, or 2:1.

In various aspects, an expanded metal having a controlled electrical resistance in any one or more dimensions can be useful in dissipating energy associated with, for example, a lightning strike, and in protecting wiring and/or electrical components from electromagnetic interference associated with a lightning strike. For example, the wiring and avionics systems of an aircraft can be better protected by a lightning protection system comprising an expanded metal having an isotropic or substantially isotropic electrical resistance. Thus, in one aspect, the expanded metal of the present disclosure, in various aspects, can act as a Faraday cage, protecting any electrically sensitive components positioned therein from electromagnetic interference.

An expanded metal can optionally be treated, for example, annealed, flattened, coated, and/or otherwise treated to impart specific physical and/or chemical properties thereto.

### Composite Material

The lightning protection system of the present disclosure can comprise a composite structure, such as, for example, a fiber reinforced polymer material. In various aspects, the fiber reinforced polymer material can comprise an expanded metal as described herein. Such an expanded metal component can be positioned at any location on or within the composite material depending upon the intended application and desire properties. In one aspect, the expanded metal can be positioned along an exterior surface of the composite material. In another aspect, the expanded metal can be positioned within, such as, for example, close to an exterior surface, of the composite material.

In one aspect, the expanded metal can be positioned such that, upon a lightning strike incident upon the expanded metal or the composite material onto or into which the expanded metal is positioned, the expanded metal or a portion thereof can vaporize, absorbing at least a portion of the energy of the incident lightning strike.

In various aspects, the composite material can be an aerospace structure, such as a fuselage, airfoil, or other control surface of an aircraft.

In other aspects, the present disclosure provides a lightning protection system comprising the expanded metal disclosed herein. Such a system can comprise multiple expanded metal components, composite materials comprising expanded metal components, and/or other optional electrical components designed to render harmless a lightning strike and to reduce or eliminate any electromagnetic interference associated therewith.

### Preparation of Expanded Metal

The present disclosure also provides methods for the manufacture of an expanded metal as disclosed herein. The recited methods and steps are intended to represent various non-limiting options for the preparation of such expanded metal components and the present invention is not intended to be limited to any particular steps.

In one aspect, an expanded metal can be prepared by forming a plurality of openings in a metal sheet good, and then stretching the metal sheet good in at least a first direction so as to form an expanded metal having a predetermined electrical resistance in each of the first direction and a second direction perpendicular thereto.

In another aspect, the specific shape and size of any one or more openings in a metal sheet good can be predetermined so as to provide the desired electrical resistance when stretched.

In other aspects, the stretching step can comprise any one or more individual stretching steps. In a specific aspect, the method can comprise a single stretching step. In another specific aspect, the method can comprise multiple stretching steps of the same or varying intensity. The specific number and intensity of any one or more stretching steps can be determined by, for example, the degree of expansion desired and the physical properties, for example, tensile strength, of the metal.

Although several aspects of the present invention have been illustrated in the accompanying drawings and described in the detailed description, it should be understood that the invention is not limited to the aspects disclosed, but is capable of numerous rearrangements, modifications and substitutions without departing from the spirit of the invention as set forth and defined by the following claims.

### EXAMPLES

To further illustrate the principles of the present invention, the following examples are put forth so as to provide those of ordinary skill in the art with a complete disclosure and description of how the compositions, articles, devices, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

### Comparison of Expanded Metals

In a first example, a traditional expanded metal (3CU7-100FA) is compared to an inventive expanded metal (2CU20-125XY), both available from Dexmet Corporation, Naugatuck, Conn., USA. The details of the materials are listed in Table 1, below.

TABLE 1
Comparison of Expanded Metals

| | Traditional | Inventive |
|---|---|---|
| Weight, lbs/SF | 0.040 | 0.040 |
| Base Metal Thickness | 0.003 in. | 0.002 in. |
| Material | C11000 Copper | C11000 Copper |
| Strand Width | 0.007 in. | 0.020 in. |
| LWD | 0.100 in. | 0.096 in. |
| SWD | 0.055 in. | 0.096 in. |
| Overall Thickness | 0.003 in. | 0.002 in. |
| Open Area | 70% | 60% |

Electrical Resistance, mΩ/square

| | | |
|---|---|---|
| Coil direction | 3.0 | 1.8 |
| Width direction | 1.1 | 1.8 |

As illustrated in Table 1, above, the electrical resistance of the inventive expanded metal is same in each direction, whereas the electrical resistance of the traditional expanded metal varies significantly between directions.

Throughout this application, various publications are referenced. The disclosures of these publications in their entireties are hereby incorporated by reference into this application in order to more fully describe the compositions, articles, device, and methods described herein.

Various modifications and variations can be made to the compositions, articles, devices, and methods described herein. Other aspects of the compositions, articles, devices, and methods described herein will be apparent from consideration of the specification and practice of the compositions, articles, devices, and methods disclosed herein. It is intended that the specification and examples be considered as exemplary.

What is claimed is:

1. An expanded metal having substantially isotropic electrical resistance in at least two dimensions.

2. The expanded metal of claim 1, wherein the electrical resistance is isotropic in the at least two dimensions.

3. The expanded metal of claim 1, wherein the at least two dimensions comprise a length and a width of a planar material.

4. A Faraday cage comprising the expanded metal of claim 1.

5. A reinforced structure comprising a composite material and the expanded metal of claim 1.

6. The reinforced structure of claim 5, wherein the composite material comprises a fiber reinforced panel.

7. A lightning protection system, comprising the expanded metal of claim 1.

8. An aerospace component comprising the expanded metal of claim 1.

9. A method of making an expanded metal, the method comprising:
a. forming a plurality of openings in a metal sheet good;
b. stretching the metal sheet good in at least a first direction so as to form an expanded metal having a predetermined electrical resistance in each of the first direction and a second direction perpendicular thereto.

10. The method of claim 9, wherein the stretching comprises a plurality of discrete stretching steps.

11. The method of claim 9, wherein the electrical resistance of the expanded metal in each of the first direction and the second direction are substantially equal.

12. The method of claim 9, further comprising forming a reinforced structure comprising the expanded metal.
